(19) United States
(12) Patent Application Publication
(10) Pub. No.: US 2006/0091222 A1
(43) Pub. Date: May 4, 2006

(54) Direct-mounted pouch for portable electronic device

(75) Inventors: Paul C. P. Leung, Vancouver (CA); Ying-Chiu Chan, Vancouver (CA); Kenneth Kee Ho, Coquitlam (CA)

Correspondence Address: BLACK LOWE & GRAHAM, PLLC, 701 FIFTH AVENUE, SUITE 4800, SEATTLE, WA, 98104, US

(73) Assignee: Empower Technologies Inc.

(21) Appl. No.: 11/258,722

(22) Filed: Oct. 25, 2005

Related U.S. Application Data
(60) Provisional application No. 60/622,093, filed on Oct. 25, 2004.

(51) Int. Cl. G06K 7/00

(52) U.S. Cl. 235/486

(57) ABSTRACT

A pouch for a portable electronic device is disclosed comprising an outer wall forming an opening secured to a portable electronic device. The outer wall includes rounded or faceted surfaces conforming to the hand of a user holding the electronic device. A compressible stylus may secure to the portable electronic device between two stops holding the stylus in a compressed position. A cover of the electronic device hingedly secures thereto and includes a catch selectively maintaining the cover in a closed position. A power switch of the electronic device is positioned proximate the catch such that substantially simultaneous release of the catch and powering on of the device are enabled.

### PRIORITY CLAIM

This Application claims the benefit of Provisional Patent Application Ser. No. 60/622,093, filed Oct. 25, 2004.

### FIELD OF THE INVENTION

This invention relates generally to portable electronic devices and, more particularly, to apparatus for storing accessories and peripherals for such devices.

### BACKGROUND OF THE INVENTION

In recent years, the number of portable electronic devices used by the typical person has increased. Personal digital assistants (PDA), MP3 players, cell phones, and the like, are ever present in today's society. Often a portable electronic device, though mostly a self contained unit, will require peripheral devices to operated. An MP3 player typically requires headphones, a cell phone may be used with a hands-free headset, and a PDA may have expansion modules, extra memory, cables, a charger, or the like. Prior devices do not include a ready way to carry peripherals. The user must either obtain a separate container to store the peripheral or simply store the peripheral in a purse or back pack where it is hard to find and may become entangled.

Accordingly, it would be an advancement in the art to provide a simple, unobtrusive means to store peripherals along with a portable electronic device.

### SUMMARY OF THE INVENTION

A pouch for securing to a portable electronic device includes an outer shell that has a lower edge conforming to an outer surface of the electronic device. The outer shell and the outer surface substantially enclose a volume for receiving peripherals, and the like, of the portable electronic device. The outer shell defines an opening which may be coverable with a lid. A fastener may secure the outer shell to the external surface of the portable electronic device. In some embodiments, the pouch hingedly secures to the portable electronic device.

In one embodiment, the pouch is adapted to fit within the palm of a partially closed hand holding the portable electronic device and pouch. The pouch may have an outer shell that has a rectangular cross-section having two truncated corners in a plane orthogonal to the external surface. The outer shell may have other faceted or rounded shapes adapting the outer shell to fit within the hand of a user.

The pouch may be used along with a collapsible stand secured to the portable electronic device at first and second points. The pouch may be positioned between the first and second points and have a shape enabling the stand to swing freely away from the case into a deployed position.

A stylus may be adapted for use with the portable electronic device and include first and second shaft members telescopically secured to one another. A biasing member may urge the first and second shaft members apart. The stylus may secure to the case between first and second stops positioned to engage the first and second shaft members, respectively. The distance between the first and second stops may be less than the less than the sum of the lengths of the first and second shaft members. The first and second stops may be embodied as the ends of a groove formed in the case of the portable electronic device.

A cover may secure to the portable electronic device to protect a screen thereof. The cover may hingedly secure near its top edge to the portable electronic device. A catch may secure an edge of the cover to the case of the portable electronic device. A switch may be secured to the portable electronic device near the catch such that the device may be powered on and the catch released substantially simultaneously. The switch and catch may be integrally connected or coupled such that releasing the catch activates the switch to power on the portable electronic device

As will be readily appreciated from the foregoing summary, the invention provides a convenient, unobtrusive means for securing a pouch to a portable electronic device for storing the peripheral devices thereof.

### BRIEF DESCRIPTION OF THE DRAWINGS

Preferred and alternative embodiments of the present invention are described in detail below with reference to the following drawings.

FIG. 1 a perspective view of a portable electronic device having a storage pouch secured thereto, in accordance with an embodiment of the present invention;

FIG. 2 is a top plan view of a portable electronic device having a storage pouch secured thereto, in accordance with an embodiment of the present invention;

FIG. 3 is a perspective view illustrating the process of securing a pouch to a portable electronic device, in accordance with an embodiment of the present invention;

FIGS. 4A and 4B are perspective views of alternative configurations of a pouch and portable electronic device, in accordance with an embodiment of the present invention;

FIGS. 5A through 5C are perspective views of alternative configurations of an opening and lid for a pouch, in accordance with an embodiment of the present invention;

FIGS. 6A through 6D are perspective views of pouches hingedly securing to the portable electronic device, in accordance with an embodiment of the present invention;

FIGS. 7A through 7K are perspective views illustrating means for securing a pouch to a portable electronic device, in accordance with an embodiment of the present invention;

FIGS. 8A through 8Y are perspective views of various stands suitable for use with a portable electronic device, in accordance with an embodiment of the present invention;

FIG. 9 is a perspective view of a compressible stylus mountable to a portable electronic device, in accordance with an embodiment of the present invention;

FIG. 10 is a top sectional view of a compressible stylus, in accordance with an embodiment of the present invention;

FIG. 11 is a top plan view of a portable electronic device having a cover, in accordance with an embodiment of the present invention;

FIG. 12 is a perspective view illustrating a process for detaching a cover from a portable electronic device, in accordance with an embodiment of the present invention;

FIG. 13 is a perspective view of an expansion module incorporating cell phone and camera functions disengaged from the portable electronic device, in accordance with an embodiment of the present invention;

FIG. 14 is a perspective view of an expansion module incorporating cell phone and camera functions engaged with the portable electronic device, in accordance with an embodiment of the present invention; and

FIG. 15 is a side cross-sectional view of a cover latch and power switch facilitating simultaneous cover release and powering on of the device.

### DETAILED DESCRIPTION OF THE PREFERRED EMBODIMENT

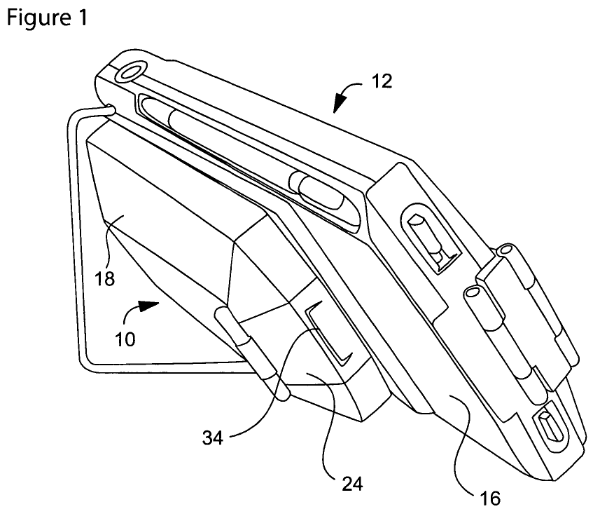

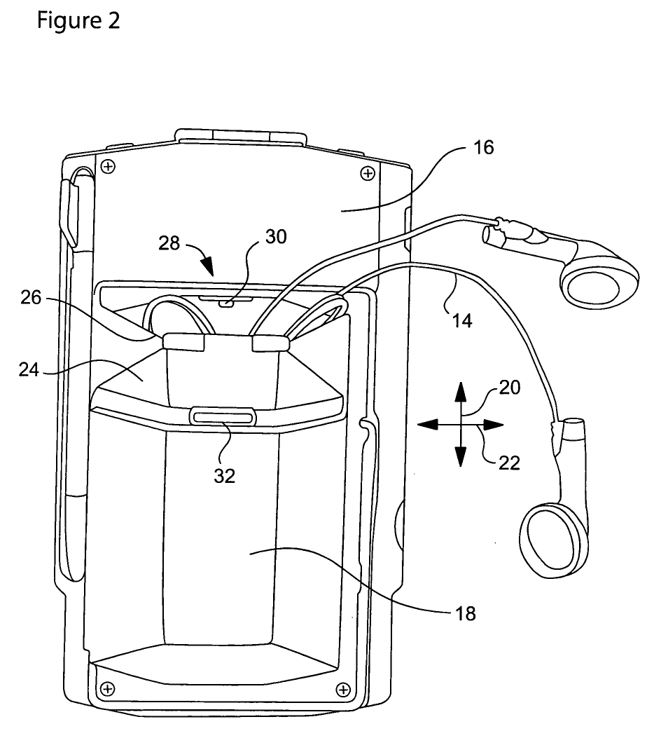

Referring to FIGS. 1 and 2, a pouch 10 may secure to a portable electronic device 12 and provide a convenient location to store accessories 14, such as headphones, microphones, batteries, cables, adapters, and the like. The pouch 10 may secure directly to a case 16 encapsulating the electronic device 12. The pouch 10 may be contoured to conform to a hand of a user. In the illustrated embodiment, an outwardly projecting wall 18 extends away from the case 16 to define a volume for receiving the accessories 14. The wall 18 may be made of various materials, including rigid materials such as metal and rigid plastic, slightly flexible material such as rubber and other flexible polymers, soft materials such as fabric or leather, or any combination of the above mentioned materials.

The wall 18 may be rounded to fit readily in a cupped hand of a user holding the device. Alternatively, the wall 18 may be multifaceted as illustrated to approximate a curved surface. In the illustrated embodiment, the wall 18 is shaped as a cubic rectangle having one or more truncated edges, corners, or both, to readily fit in the hand of a user. In the illustrated embodiment, the wall 18 has a profile in a plane orthogonal to a longitudinal direction 20 shaped as a rectangle having truncated corners. The profile of the wall 18 in the plane orthogonal to a lateral direction 22 may likewise be a truncated rectangular or trapezoidal shape to better conform to a hand of a user. Other faceted shapes may also be used to accommodate the hand of a user.

A lid 24 may secure to the outer wall 18 near an opening 26 formed therein. The lid 24 may likewise have a rounded or faceted outer surface to conform to the hand of a user. The lid 24 may hingedly secure to an edge of the opening 26. A catch 28 may retain the lid 24 in a closed orientation. In one embodiment, the catch 28 includes a hook 30 secured to the pouch 10 proximate the case 16 which engages a groove 32 formed on the lid 24. A second groove 34, or tab 34, on the exterior surface of the lid 24 may facilitate gripping by a user to open the lid 24.

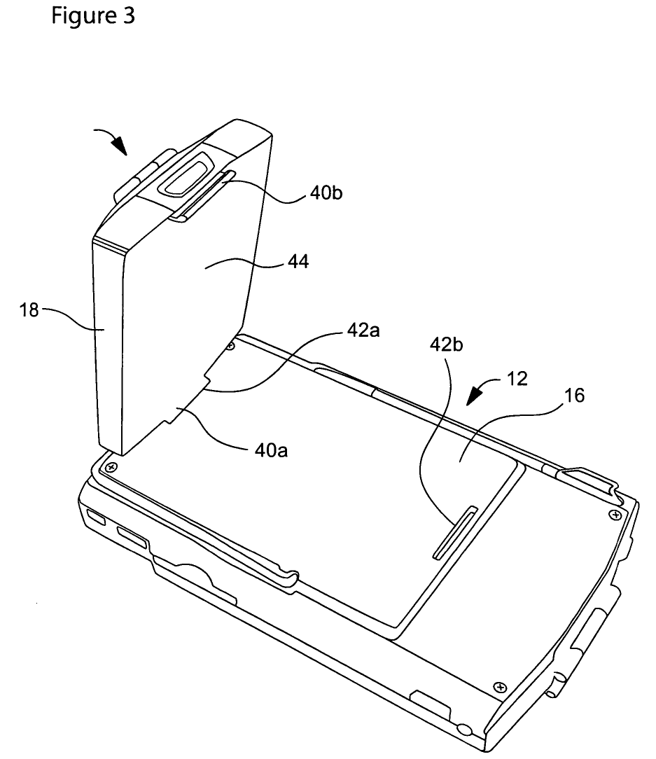

Referring to FIG. 3, the pouch 10 may detachably secure to the case 16. In the illustrated embodiment, hooked tabs 40a, 40b are retained within slots 42a, 42b to retain the pouch 10. In some embodiments, the tabs 40a, 40b are formed on an inner wall 44 of the pouch 10. Alternatively, in some embodiments, the pouch 10 may be formed without an inner wall 44, such that the outer wall 18 and the case 16 of the electronic device 12 define a volume. In such embodiments, the tabs 40a, 40b may secure to a lower edge of the outer wall 18. The tabs 40a, 40b may be elastically deformable to enable a user to remove the tabs 40a, 40b from the slots 42a, 42b by deforming the tables 40a, 40b to disengage the hooked portion thereof. In alternative embodiments, tabs 40a, 40b may be formed on the case 16 whereas slots 42a, 42b are formed in the wall 44. To secure the pouch 10 to the case 16, a user may first position one tab 40a within the slot 42a and then pivot the pouch 18 toward the case 16 to engage the tab 40b with the slot 42b.

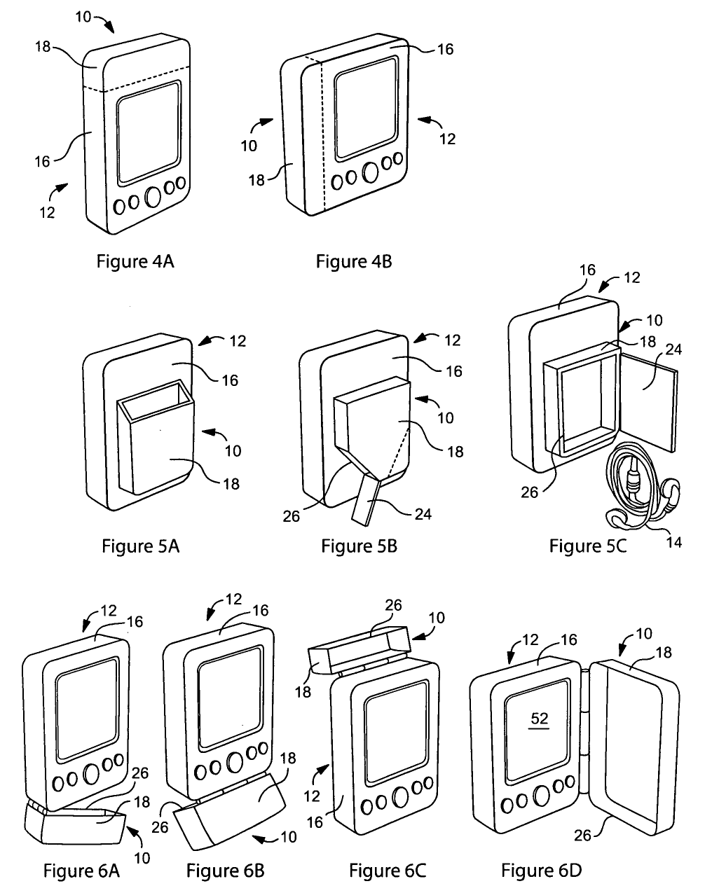

Referring to FIGS. 4A-4C, a pouch 10 may secure to the case 16 at a variety of positions, in addition to the back of the case 16 as shown in FIGS. 1-3. For example, at the top or bottom in the configuration of FIG. 4B, or at the lateral sides as in FIG. 4C. Various configurations of the lid 24 are likewise contemplated. For example, the lid 24 may be omitted, as in the embodiment of FIG. 5A. Objects may simply be retained within the pouch 10 by friction. In such embodiments the wall 18, or a portion thereof may be elastic such that objects are retained by a restoring force exerted by the wall 18. For example, the opening 26 may be elastically retained in a constricted position. In the embodiment of FIG. 5B, the lid 26 may be part of an angled surface secured over an opening 26 positioned at a truncated corner of a cubic rectangular outer wall 18. In the embodiment of FIG. 5C, the lid 24 comprises a substantial portion of a rear surface of the outer wall 18, with the remainder of the outer wall 18 forming upper, lower, and lateral walls of the pouch.

Referring to FIGS. 6A-6D, in some embodiments, the pouch 10 hingedly secures to the case 16. An opening 26 may be located adjacent the case 16, such that access to the pouch 10 is provided by pivoting the outer wall 18 away from the case 16 to expose the opening as shown in FIG. 6A. The axis of rotation of a hinged pouch 10 may be disposed along a lateral edge of the case 16 as in FIG. 6A or along a forward or rearward edge as in FIGS. 6B and 6C. In some embodiments the axis of rotation of the hinged pouch 10 is disposed along a forward or rearward vertical edge as in FIG. 6D. In such embodiments, the pouch 10 may serve as a cover for a screen 52 of the electronic device 12.

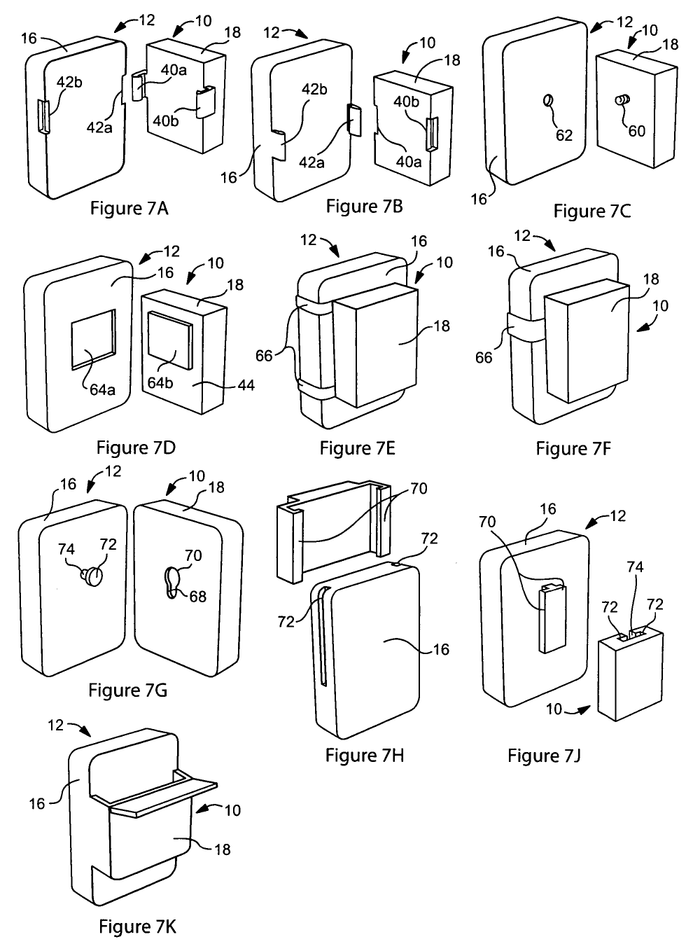

The pouch 10 may secure to the case 16 by a variety of means. For example, hooked tabs 40a, 40b may secure to the lateral sides of the pouch 10 and engage slots 42a, 42b, or corresponding hooks 42a, 42b formed on the lateral sides of the case 16 as in FIG. 7A. Alternatively, the hooked tabs 40a, 40b may be secured to the case 16 and engage slots 42a, 42b, or hooks 42a, 42b formed on the pouch 10, as in the embodiment of FIG. 7B. Alternatively, a threaded post 60 may secure to the inner wall 44 of the pouch 10 and engage a corresponding threaded aperture 62. The post 60 may thread into the aperture 62 by rotating the entire pouch 10 or may be a screw or bolt extending through an aperture in the pouch, such that a screw driver, wrench, or other tool is used to thread the post into the aperture 62.

In the embodiment of FIG. 7D, adhesive members 64a, 64b may secure to the case 16 and the inner wall 44, respectively. In one embodiment one of the adhesive members 64a, 64b is a ferromagnetic material whereas the other is a magnet. Alternatively, both adhesive members 64a, 64b may be embodied as magnets. In other embodiments, the adhesive members 64a, 64b are embodied as a VELCRO fastening system. In still other embodiments, the adhesive members 64a, 64b may be embodied as adhesive tape. In such embodiments, a single adhesive member 64a, 64b may be used.

Referring to FIGS. 7E and 7F, in some embodiments one or more straps 66 may secure the pouch 10 to an electronic device 12. The straps may be tensionable by means of VELCRO, buckles, snaps, or like fastening means. In the embodiment of FIG. 7E multiple straps 66 are used. In such embodiments, the straps 66 may be positioned above and below a screen 52 in order to avoid obstructing the screen 52. In the embodiment of FIG. 7F a single strap 66 is used, which may have a portion thereof formed of a transparent material to avoid obstructing the screen 52 of electronic devices 12 having screens.

Referring to FIG. 7G, in some embodiments a pouch 10 may include a slot 68 and an aperture 70 to receive a head 72 secured to a post 74. The head 72 and post 74 may be inserted within the aperture 70 and the post 74 subsequently slid into the slot 68 to secure the pouch 10 to the case 16. The slot 68 may retain the post within the slot 68 by means of a friction fit or a detent mechanism, such as a bulge or constriction at the top of the slot 68. In some embodiments, the head 72 and post 74 are formed on the case 16 and the slot 68 and aperture 70 formed in the pouch 10.

Referring to FIG. 7H, in some embodiments a pouch 10 includes rails 70 engaging slots 72 formed on, or secured to, the sides of the case 16. Referring to FIG. 7J, slots 72 may be secured to the pouch 10 on either side of a central slot 74 and engage rails 70 secured to the case 16 by means of an offset 76, which is located within the central slot 74 when the pouch 10 is engaged with the case 16. A detent mechanism, friction fit, latch, or the like may retain the rails 70 within the slots 72.

Referring to FIG. 7K, the pouch 10 may alternatively be integrally or monolithically formed with the case 16. The lid 24 in such embodiments may be omitted as well as the inner wall 44. As in all illustrated embodiments, the outer wall 18 may be cubic rectangular shape as illustrated, or be a faceted or rounded to better conform to a hand of a user.

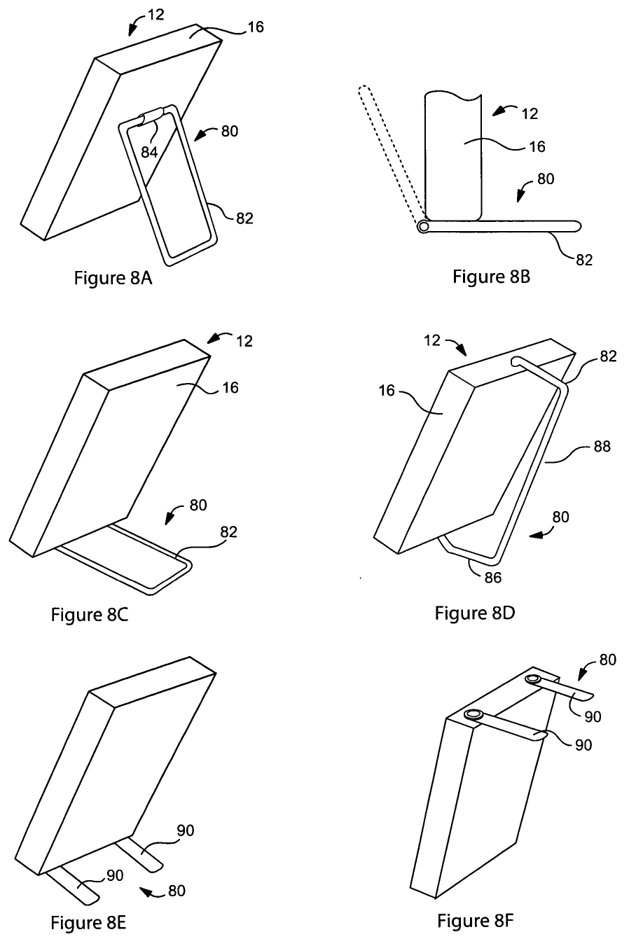

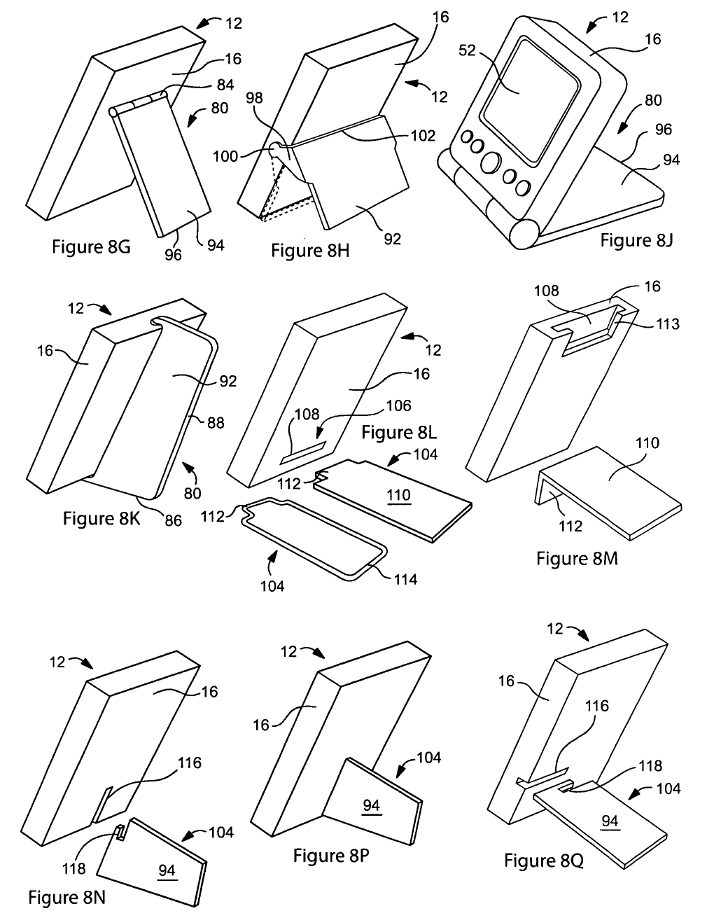

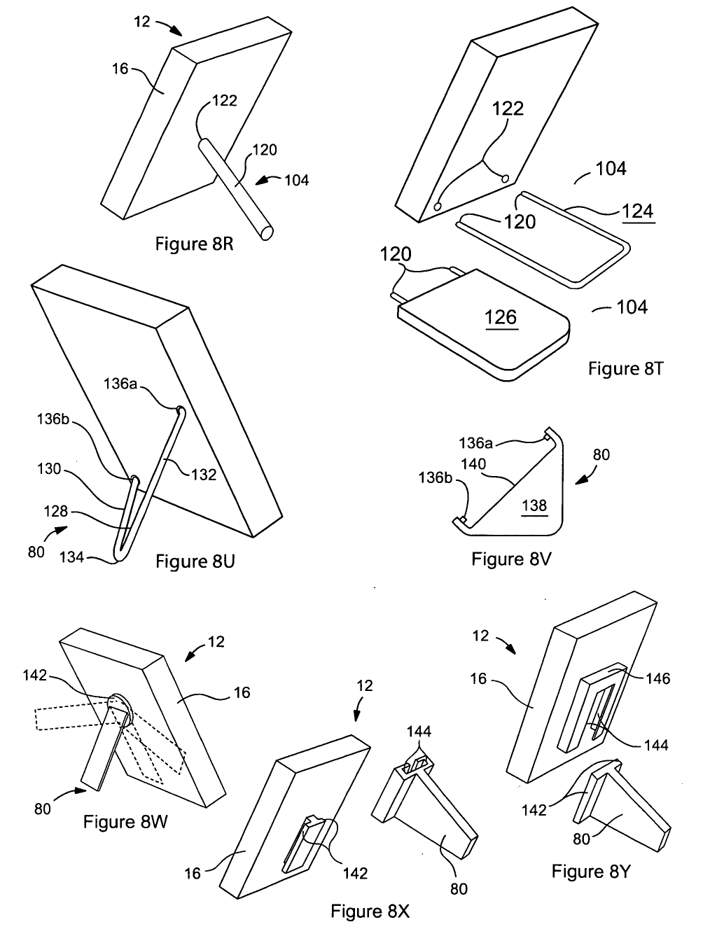

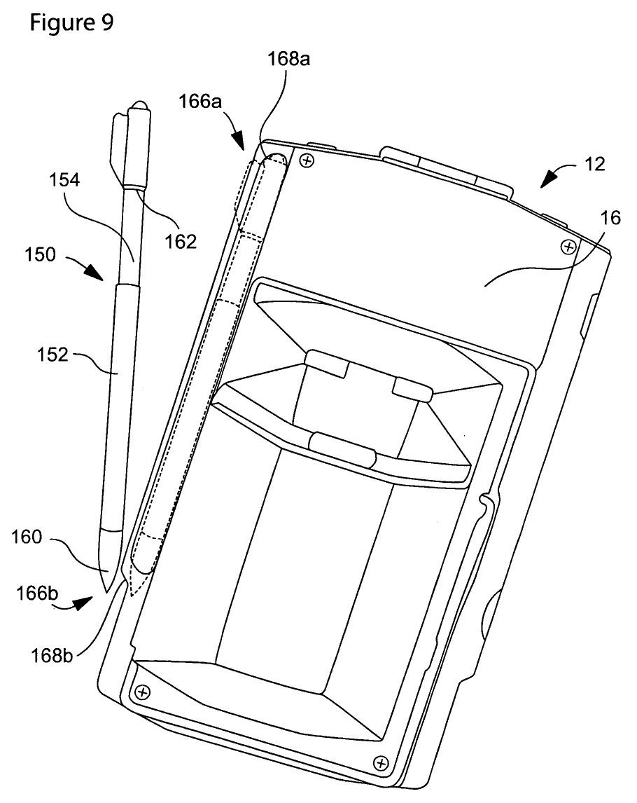

Referring to FIGS. 8A through 8Y, a stand 80 may secure to the case 16 and be positionable to support the case 16 in an orientation to display information on the screen 52. A stand 80 may support a portable electronic device 12 such as a camera for automatic picture taking or a portable digital assistant during synchronization with another device. In the embodiment of FIG. 8A, a frame 82, which may be formed of a rectangular loop of stiff wire, pivotally secures to a raised portion 84 secured to the rear surface of the case 16. Alternatively, the frame 82 may pivotally secure to the lateral edges of the case 16 to accommodate the pouch 10. The frame 82 may pivot toward the case 16 into a stowed position next to the case 16 and pivot away from the case 16 into a deployed position suitable for supporting the case 16 on a surface.

In the embodiment of FIGS. 8B and 8C, the frame 82 pivotally mounts near the bottom front edge of the case 16 and pivots between a stowed position, represented by dashed lines proximate the front surface of the case 16, to a deployed position, shown in solid lines, wherein the frame 82 extends rearwardly. The wire may be angled to present the screen 52 in an angled position. Alternatively, the bottom surface of the case 16 may be angled such that the frame 82 when laid flat against the lower surface is angled relative to the screen 52, as shown in FIG. 8C. In yet another alternative, slots extending through the case 16 may receive the frame 82 such that the frame 82 supports the case 16 at an angle.

Referring to FIG. 8D, in some embodiments the frame 82 may extend between the top and bottom surfaces of the case 16 and pivot about a longitudinally extending axis. The frame may include a truncated corner 86, or angled portion 86, to support the case 16 in an angled position. The longitudinal portion 88 of the frame 82 may support the case 16 with the longitudinal axis thereof positioned parallel to a support surface. A stop may engage the frame 82 to maintain the frame 82 at a suitable angle relative to the case 16, such as the position illustrated in FIG. 8D, to support the case 16 with the longitudinal axis parallel to a support surface.

Referring to FIGS. 8E and 8F, in some embodiments, a stand 80 may include one or more legs 90 pivotally secured to the bottom surface of the case 16. The legs 90 may pivot about a longitudinally extending axis between a stowed position extending along the bottom surface of the case 16 and a deployed position extending rearwardly from the case 16. The legs 90 may secure to the case 16 at slightly different heights such that they may be positionable under the bottom surface overlapping one another. The legs 90 may be at an acute angle relative to a screen such that they support the case 16 in a tilted orientation, or may secure to a bottom surface that is itself at an acute angle relative to the screen 52, such that the legs 90 extend rearwardly at a suitable angle relative to the screen 52.

Referring to FIGS. 8G through 8K, in some embodiments, the stand 80 is embodied as plate 94 of material having a perimeter providing a lower edge 96 suitable for supporting the case 16 in tilted orientation. The plate may hingedly secure proximate its upper end to the lateral edges of the case 16, as in FIG. 8H or to a raised portion 84 secured to the case 16, as in FIG. 8G. The plate 92 of FIG. 8G may be a trapezoid having its base hingedly attached to the case or a triangle, such that one or more angled edges thereof facilitate support of the stand in substantially vertical and substantially horizontal positions. The plate 92 of FIG. 8G may hingedly move along either a longitudinal or horizontal axis. The plate 92 may also hingedly secure to top and bottom surfaces of the case 16 as in the embodiment of FIG. 8K and provide an angled edge 86 and longitudinal section 88 for supporting the case 16 in substantially vertical and longitudinal orientations. Portions of the plate 92 may be removed to decrease weight and production costs. The embodiments of FIGS. 8H and 8K may secure to ears 98 extending from the plate 92 to a point 100 that is offset from an edge 102 of the plate 92, such that the case 16 may rest on the edge 102 with the plate 92 in an angled position. In such embodiments, the plate 92 may still be laid flat against the case 16 as shown in dotted lines.

Referring to FIGS. 8L-8Q, in some embodiments a stand 80 may be embodied as a detachable member sized to engage a receiver 106 secured to the case 16. In the embodiment of FIG. 8L, the receiver is a horizontal aperture 108 formed near the lower surface of the case 16 and the detachable member 104 is a plate 110 having a tongue 112 sized to fit within the aperture. Alternatively, a wire member 114 having a perimeter similar to the plate 110 and tongue 112 may be used. Plate 110 or wire member 114 may be retained within the aperture 108 by gravity, inasmuch as the tilted case 16 will drive the upper edge of the aperture 108 against the plate 110 or wire member 114. Alternatively, a detent mechanism may retain the plate 110 or wire member 114 within the aperture 108. For example, a raised member formed in the aperture 108 may engage a groove formed in the plate 110 or an inner surface of the wire member 114. Alternatively, a groove formed in the aperture 108 may engage a raised portion on the plate 110 or the wire member 114.

In the embodiment if FIG. 8M, the tongue 112 is angled with respect to the rest of the plate 110. The aperture 108 may likewise extend into the case 16 at an angle or parallel to the back of the case 16. In such embodiments, the aperture 108 may be sufficiently deep that the plate 110 may be inserted within the aperture having the tongue 112 extending over the bottom of the case 16 for storage. The aperture 108 may extend through a bottom surface of the case 16 and have a notch 113 to accommodate the outwardly extending plate 110.

Referring to FIGS. 8N and 8PN, in some embodiments, the detachable member 104 may be embodied as a plate 94 engaging a slot 116 formed in the case 16. The plate 94 may have a corresponding slot 118 formed therein to capture a portion of the case 16 in order to support the case 16. The plate 94 may be retained within the slot 116 by the weight of the electronic device 12. Alternatively, a detent mechanism may retain the plate 94 within the slot 116 as described for other embodiments of the stand 80. The slot 116 may extend vertically along the case 16, as in FIGS. 8N and 8P, or horizontally, as in FIG. 8Q.

Referring to FIG. 8R, in some embodiments the detachable member 104 may be a post 120 insertable into an aperture 122 sized to snugly receive the post 120. The post 120 may be retained by means of friction, gravity, or a detent mechanism as described for other embodiments of the stand 80. In the embodiment of FIG. 8T, the detachable member 104 has two or more posts 122 inserting into multiple apertures 122. The detachable member 104 in such embodiments may be embodied as a U-shaped wire 124 or a plate 126 having the posts 122 secured thereto or formed monolithically therewith.

Referring to FIG. 8U, while referring again to FIG. 1, in some embodiments a stand 80 may serve to support the portable electronic device 12 in both upright and horizontal positions. This configuration further facilitates use of a pouch 10 while the portable electronic device 12 is in both upright and horizontal positions. The stand 80 may be embodied as a wire 128 having a vertical support section 130 and a horizontal support section 132 joined at an apex 134 and having end portions 136a 136b which extend collinearly.

The ends 136a, 136b may secure at points near the bottom and lateral sides of the case 16, or to the rear surface proximate the bottom and lateral sides, respectively, having the line of collinearity oriented at an acute angle, such as 45 degrees, relative to a longitudinal or horizontal axis. The stand 80 may pivot about the ends 136a, 136b between a deployed position in which the stand 80 lays substantially flat against the case 16 and a deployed position in which the stand 80 extends rearwardly from the case 16. A pouch 10 as shown in FIG. 1, may be particularly useful in conjunction with the stand 80 of FIG. 8U, inasmuch as its rounded, or faceted, outer shell 18 may provide for a large encapsulated volume within the pouch 10 while not interfering with pivoting of the stand 80 between deployed and stowed orientations.

Referring to FIG. 8V, in some embodiments the ends 136a, 136b, vertical support section 130 and horizontal support section may be formed as parts of a plate 138. The ends 136a, 136b may extend into a cutaway portion 140, which accommodates the case 16 such that the plate 138 may pivot freely about the ends 136a, 136b without interference from the case 16.

Referring to FIG. 8W, a stand 80 may hingedly secure to a rotating member 142 rotatably securing to the case 16. The rotating member may enable the stand 80 to support the portable electronic device 12 in both vertical and horizontal orientations as well as 180 degree rotations from these orientations. The hinged securement of the stand 80 to the rotating member 142 may enable the stand 80 to be lain flat against the case 16 for storage. The stand 80 may secure to the rotating member 142 such that its hinged movement is limited to an acute angle sufficient to provide a stable support for the portable electronic device 12. The rotating member 142 may be embodied as a round member, such as a rivet or post mounted within a round aperture formed in, or secured to, the case 16.

Referring to FIG. 8X, the case 16, which engage slots 144 formed in the stand 80. Alternatively, the rails 142 may secure to the stand 80 and the slots 144 may be secured to the case 16, as in the embodiment of FIG. 8Y. A stop 146 may prevent upward sliding of the stand 80 when the rails are fully inserted within the slots 144.

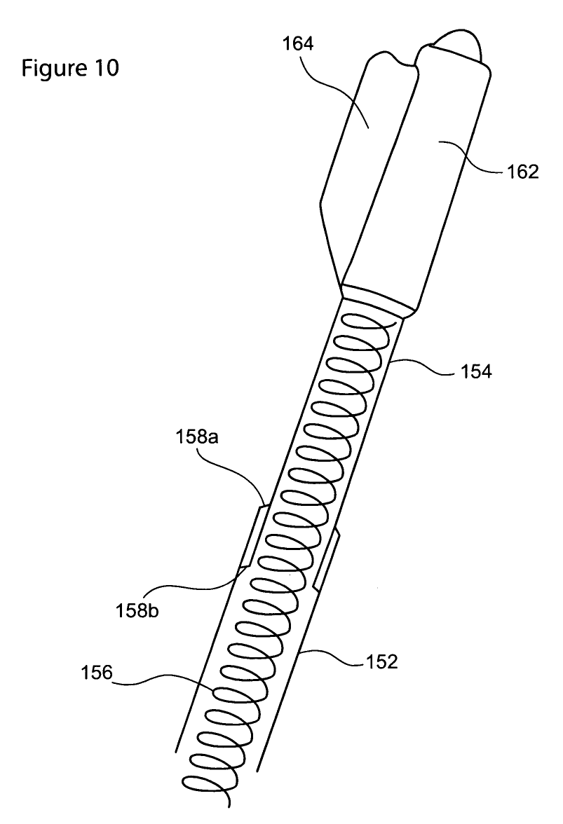

Referring to FIGS. 9 and 10, portable electronic device 12 embodied as a personal digital assistant having a touch screen may benefit from having a stylus 150 securable to the case 16. In one embodiment of the present invention, a stylus 150 includes a first shaft member 152 and a second shaft member 154 telescopically secured to one another. A biasing member 156 may be positioned within the first and second shaft members and urge them apart. The biasing member 156 may be embodied as a compression spring, or other elastic structure. Catches 158a, 158b may secure to the first and second shaft members 152, 154 to and engage one another to prevent the biasing member from completely separating the first and second shaft members 152, 154.

The first shaft member 152 may be the primary member gripped by a user using the stylus and may therefore have a larger diameter than the second shaft member 154 and may also have a grip secured thereto. A tip 160 may secure to the first shaft member 152, or may be monolithically formed therewith, for engaging a touch screen 52. A cap 162 may secure to an end of the second shaft member 154 and may include an ear 164 gripable by a user to urge the second shaft member 154 toward the first shaft member to compress the biasing member 156.

The case 16 may include stops 166a, 166b positioned to engage the first and second shaft members 152, 154, respectively. In some embodiments the stops 166a, 166b may be embodied as pockets 168a, 168b formed at either end of a groove 170. A user may store the stylus 150 by positioning the stylus 150 between the stops 166a, 166b such that the biasing member 156 exerts a restoring force, urging the first and second shaft members 152, 154 against the stops 166a, 166b. A user positioning the stylus 150 between the stops 166a, 166b may urge the first and second shaft members 152, 154 toward one another, position the stylus 150 between the stops 166a, 166b, and then permit the first and second shaft members 152, 154 to move apart into engagement with the stops 166a, 166b. This may be accomplished by positioning the tip 160 against the first stop 166b, pressing on the ear 156 to shorten the stylus 150, laying the stylus between the stops 166a, 166b, and releasing the ear 164.

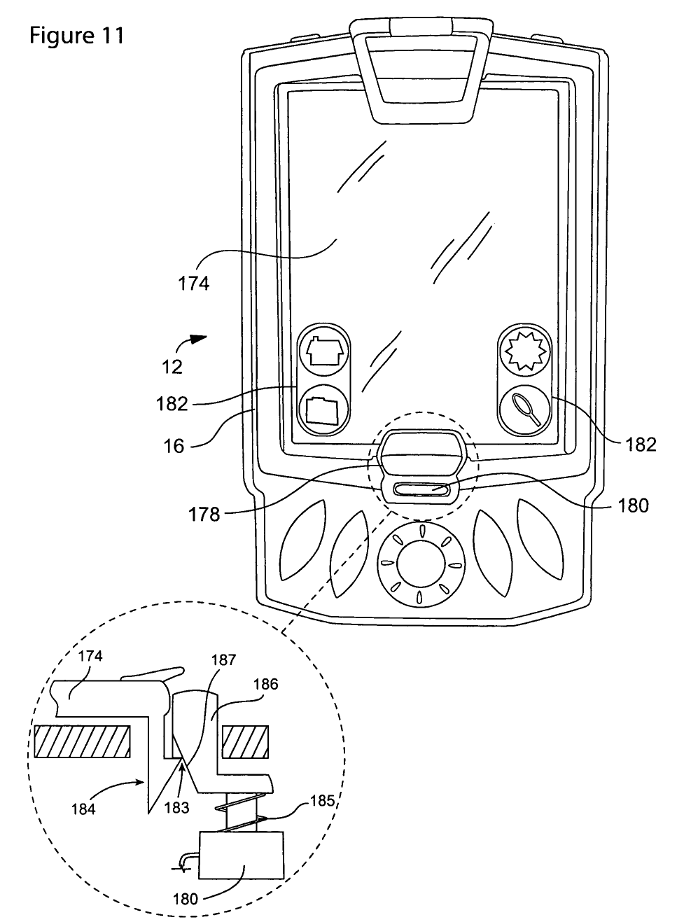

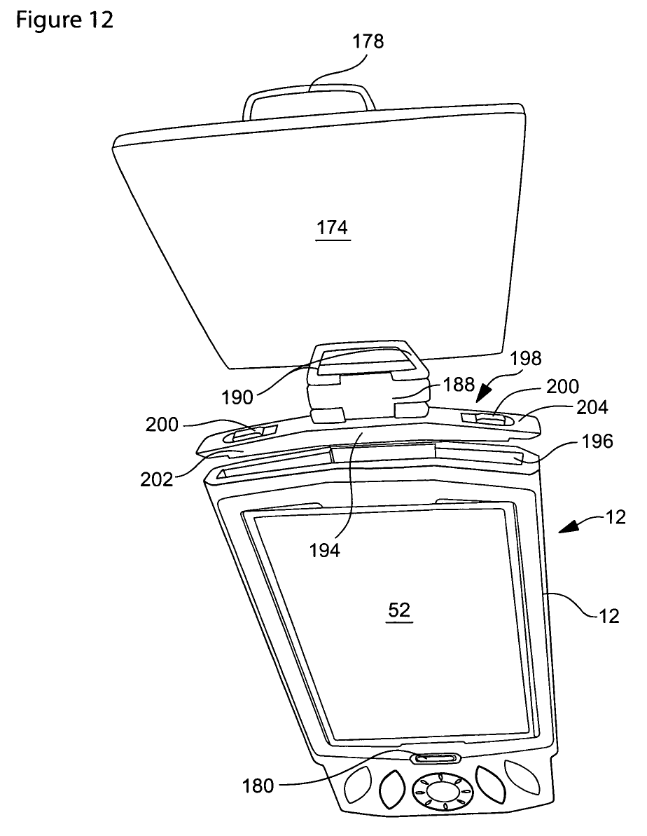

Referring to FIGS. 11 and 12, a cover 174 may be positionable over a screen 52 to protect the relatively delicate screen 52 from damage. The cover 174 may be made of a transparent material such that information displayed on the screen 52 is visible therethrough. The cover 174 is typically formed of a rigid material. The cover 174 may also be formed of a scratch resistant material or coated or treated to be scratch resistant. A tab 178 may secure to the cover 174 and be gripable by a user to pull the cover 174 away from the screen 52.

A power switch 180 may be positioned adjacent the tab 178 such that a user may substantially simultaneously switch on the portable electronic device 12 and open the cover 174. For example a user may press the power switch 180 with a finger tip, then, while lifting the finger tip from the switch 180, pull up on the tab 178.

In an alternative embodiment the power switch 180 is located in a path of travel of the cover 174 as the cover 174 swings from a closed position covering the screen 52 to an open position leaving the screen 52 exposed. In such embodiments, the cover 174 may engage the switch 180 to power on the portable electronic device 12 upon opening of the cover 174. The cover 174 may have a number of apertures 182 formed therein such that a user may access portions of a touch sensitive screen 52 while the cover 174 is closed. The holes 182 may be positioned over portions of the screen 52 used to activate frequently used functions.

In still other embodiments, a catch 183 secured to the case 16 captures a latch 184 such as a hook, tab, or other structure secured to the cover 174. In some embodiments, the catch 183 may be selectively disengaged, such as by a user's finger, from the latch 184 to release the cover 174. The catch 183 may be coupled to the switch 180 such that releasing the catch 183 powers on the electronic device 12. The catch 183 may include a spring 185 biasing a sear 187 toward a position permitting capture of the latch 184 against a portion of the case 16 and engageable with the latch 184 to release the latch 184 from engagement with the case 16. The sear 187 may alternatively be embodied as a hook, tab or like structure disengaging the latch 184 from the case 16. The catch 183 may include a gripable portion 186 for engaging the finger of a user.

In some embodiments, the cover 174 hingedly secures to the case 16. The cover 174 may hingedly secure directly to the case 16 or to a spacer 188 that is in turn hingedly secured to the case 16. The spacer 188 may be sized to span the thickness, or part of the thickness, of the case 16 such that the spacer 188 hingedly secures to the case 16 spaced away from a front edge of the case 16 and yet positions the hinged edge of the cover 174 proximate the front surface of the case 16. Hinged securement of the spacer 188 spaced apart from the front surface of the case 16 may enable the cover 174 to be rotated into a position behind the case 16, such that a user may simultaneously hold the cover 174 out of the way and grip the case 16 during use. In the illustrated embodiment, the spacer 188 mounts near the middle of the top of the case 16 such that the lid 174 lies flat when positioned over both the front and back surfaces of the case 16.

A lid 174 may further include one or more strips 190 extending from the cover 174 to the spacer 188, or to a point of hinged securement to the case 16. The strip 190 may be formed of a rigid or flexible material. The strip 190 may serve to reduce the amount of material constituting the cover 174 to the amount necessary to cover the screen 52 by spanning the distance between the cover 174 and a point of hinged securement at the top of the case 16 or to the location of the spacer 188. In the illustrated embodiment, the strips 190 are two sides of a trapezoidal member.

The cover 174 may secure to the case 16 by means of a detachable insert 194. The insert 194 may directly connect to the cover 174 or spacer 188 and detachably secure to the case 16. The insert 194 may insert into a bay 196 sized to receive the insert. A latching system 198 enables a user to remove the insert 194. In one embodiment, the latching system 198 includes one or more buttons 200 actuating hooks, tabs, or other such members that are moved into and out of engagement with the case 16 to attach or release the insert 194. The insert 194 may include an inserted portion 202 which fits within the bay 196 and a cover plate 204 positioned above the inserted portion 202 and having a portion thereof extending beyond the edge of the bay 196 when the insert 194 is engaged with the bay 196.

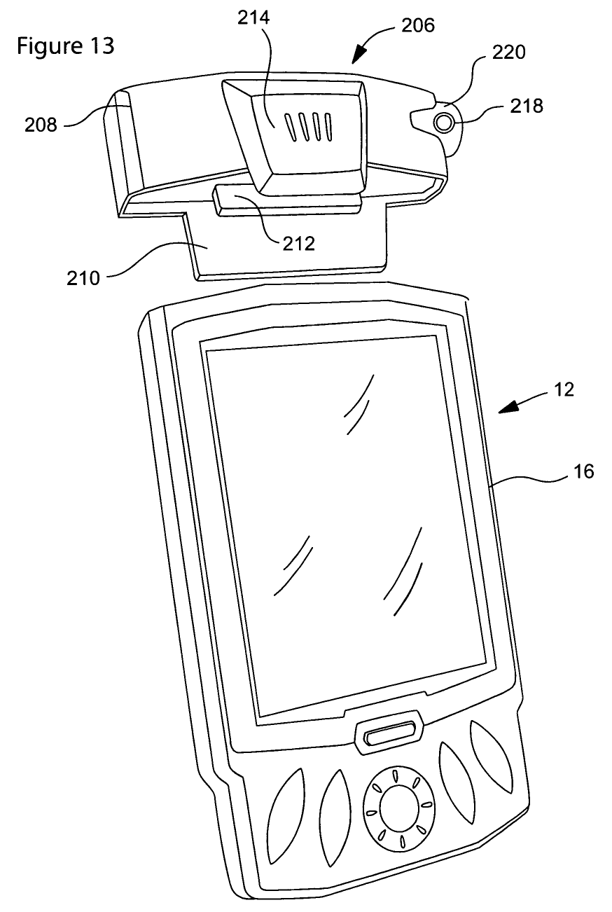

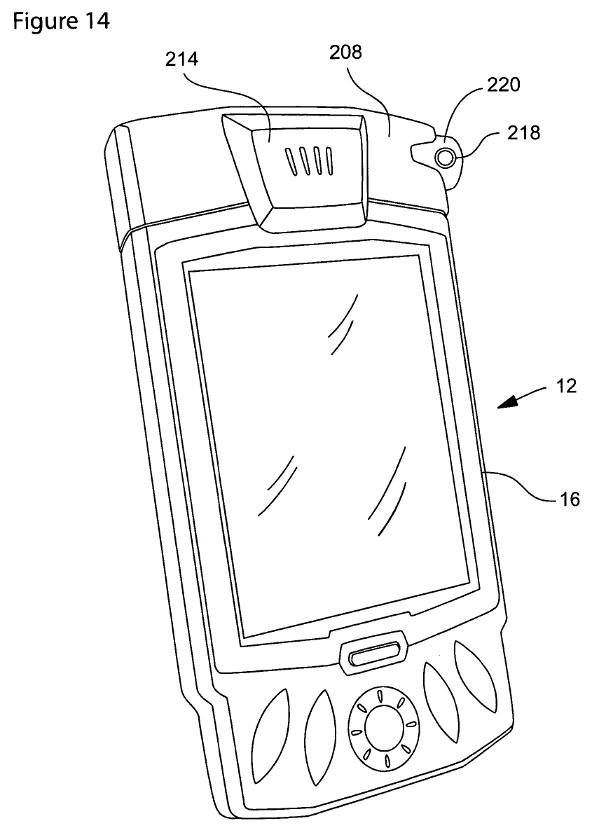

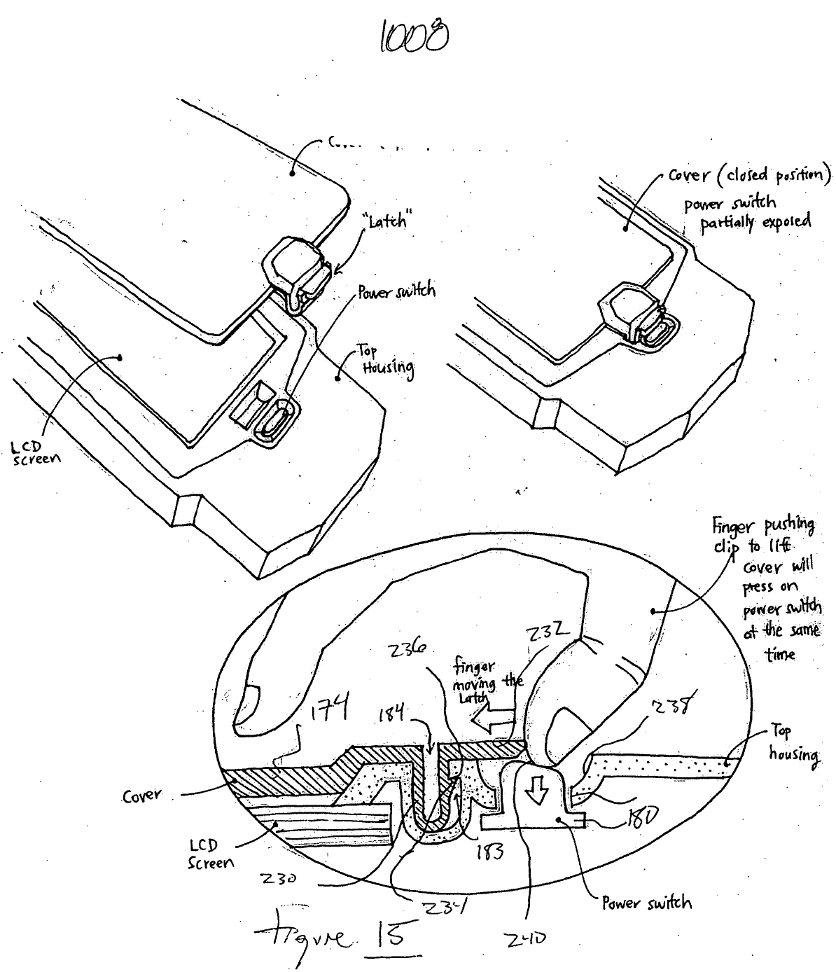

Referring to FIGS. 13 and 14, the bay 196 may serve to receive an expansion module 206. The expansion module 206 may include a cell phone module, camera module, memory module, global positioning system (GPS) module, or the like. The expansion module may have a top-mounted portion 208 extending upwardly from a top of the case 16. Expansion modules 206 requiring greater space may include a back portion 210 extending along a back surface of the case 16. A contact plate 212 may extend downwardly from the top-mounted portion 208 into the bay 196 and contain electrical contacts for communicating power and data between the portable electronic device 12 and the expansion module 206. The bay 196 may include a socket sized to receive the contact plate 212. The expansion module 206 may secure within the bay in a like manner as the insert 194 securing the cover 174 to the case 16. Accordingly, the expansion module 206 may include hooks, tabs, or other members movable in and out of engagement with the bay 196 to secure or release the expansion module 206. The expansion module 206 or case 16 may likewise be provided with buttons 200, or like actuating means, for releasing the expansion module 206 from the case 16.

An expansion module 206 embodied as a cell phone module may include an ear piece 214. The ear piece 214 may be raised with respect to the surface of the top-mounted portion 208. A raised ear piece 214 may facilitate positioning of the ear piece 214 against the ear, inasmuch as it is easily identified by feel. Inasmuch as the case 16 and top-mounted portion 208 are fairly wide, the raised ear piece 214 may be particularly useful.

A cell phone module or a camera module may incorporate a camera, including a lens 218. The lens 218 and other components of the camera, such as the shutter and light sensing components, may be mounted to a rotatable member 220. The rotatable member 220 may facilitate automated picture taking inasmuch as the portable electronic device 12 and expansion module 206 may be placed on a support surface and the lens 218 pointed in the desired direction. The shutter release button of an expansion module 206 incorporating a camera may be mounted to the expansion module 206. Alternatively, buttons or a touch screen of the portable electronic device 12 may control the shutter of the expansion module 206 and communicate with the expansion module 206 as to when the shutter is to be released.

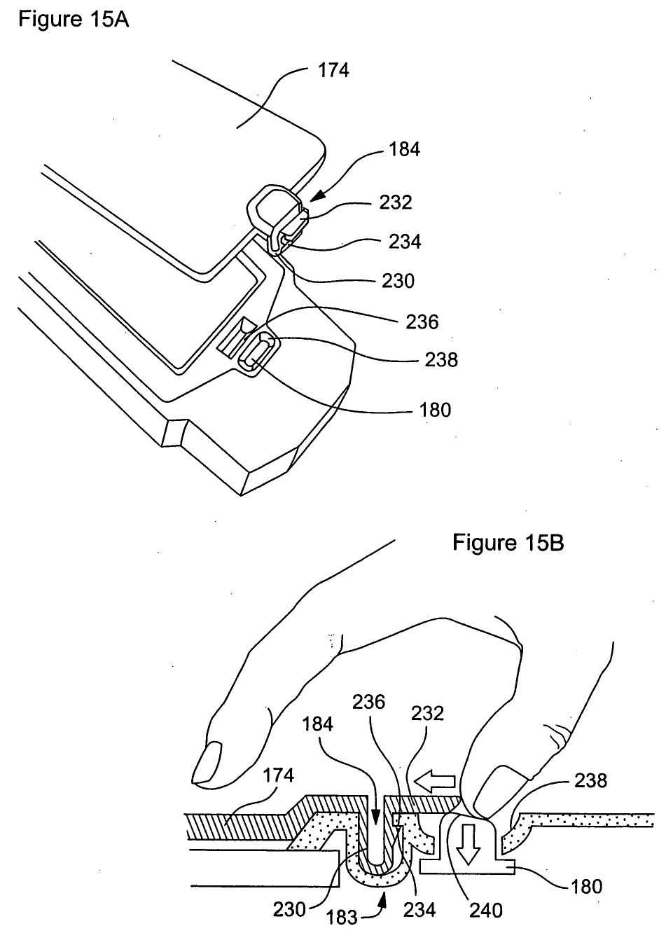

Referring to FIG. 15, in one embodiment of the invention, the latch 184 is formed on a U-shaped portion 230 secured by one of its legs to the free end of the cover 174. A release tab 232 secures to the other leg of the U-shaped portion 230. A hook 234 secures the U-shaped portion 230 and engages a catch 184 formed as a shoulder 236 formed in the case 16. The switch 180 is positioned near the release tab 232, such as within a depression 238 positioned partially beneath the release tab 232. The U-shaped portion 230 may be deformable such that the hook 234 is disengagable from the shoulder 236 to permit release of the cover 174. A user releasing the cover may simultaneously press the finger against the switch 180 and push the release tab 232 to deform the U-shaped portion 230, thereby releasing the latch 184. The switch 180 may have a sloped top 240 such that horizontal motion of the finger to release the latch 184 is converted into a downward movement in the switch 180.

The preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A pouch for securing to a portable electronic device, the pouch comprising:
an outer shell having a lower edge adapted to conform to an external surface of the electronic device, the outer shell and external surface substantially enclosing a volume, the outer shell defining an opening and comprising a lid selectively closing the opening; and
a fastener securing the outer shell to the external surface;

2. The pouch of claim 1, wherein the outer shell comprises a rigid material.

3. The pouch of claim 1, wherein the lid hingedly secures to the outer shell.

4. The pouch of claim 1, wherein the outer shell is adapted to secure to a back surface of the portable electronic device opposite a display thereof.

5. The pouch of claim 4, wherein the outer shell is adapted to fit within the palm of a partially closed hand.

6. The pouch of claim 5, wherein the outer shell has a rectangular cross-section having two truncated corners in a plane orthogonal to the external surface.

7. The pouch of claim 5, further comprising a collapsible stand adapted to secure to the portable electronic device at a first and a second positions, a portion of the pouch being located between the first and second positions.

8. The pouch of claim 7, wherein the first position is proximate a lateral edge of the portable electronic device and the second position is proximate a bottom edge of the portable electronic device.

9. The pouch of claim 7, wherein the stand is adapted to hingedly attach to the portable electronic device.

10. A portable electronic device comprising:
a stylus comprising
first and second shaft members telescopically secured to one another, and a biasing member urging the first and second shaft members apart;
a case having first and second stops engaging the first and second shaft members, respectively, the first and second stops separated by a distance less than a sum of the lengths of the first and second shaft members.

11. The portable electronic device of claim 10, wherein the first shaft member comprises a tip adapted for contacting a touch screen and a grip portion adapted to be held by a hand of a user.

12. The portable electronic device of claim 11, wherein the first and second shaft comprise cylindrical potions and wherein the biasing member is disposed within the cylindrical portions.

13. A method for storing a stylus, the method comprising:
providing a device case having first and second stops spaced apart by a first distance;
providing a stylus comprising first and second shaft members telescopically secured to one another and a biasing member urging the first and second shaft members apart;
urging the first and second shaft members into a configuration having a length shorter than the first distance; and
positioning the stylus between the first and second stops.

14. The method of claim 13, further comprising again urging the first and second shaft members into a shortened configuration and removing the stylus from between the first and second stops.

15. The method of claim 14, wherein the first and second stops comprise pockets adapted to receive the first and second shaft members, respectively.

16. The method of claim 15, wherein the first shaft member comprises a tip adapted for contacting a touch screen and a grip portion adapted to be held by a hand of a user.

17. The method of claim 16, wherein the first and second shaft comprise cylindrical portions and wherein the biasing member is disposed within the cylindrical portions.

18. A portable electronic device comprising:
a case;
a screen for displaying graphical information mounted to a front side of the case;
a cover selectively positionable over the screen having a tab proximate the edge thereof for lifting the cover; and
an on/off switch securing to the case adjacent the tab.

19. The portable electronic device of claim 18, wherein the cover hingedly secures to the case proximate an upper end thereof, and wherein the on/off switch is positioned below the catch.

20. The portable electronic device of claim 19, wherein the cover comprises a transparent portion.

21. The portable electronic device of claim 18, wherein the cover defines at least one aperture positioned over an active portion of the screen, the active portion being touch-sensitive to activate a computing function of the portable electronic device

22. A method for using a portable electronic device, the method comprising:
providing a case;
providing a screen for displaying graphical information mounted to a front side of the case;
providing a cover selectively positionable over the screen and having a tab engageable to lift the cover;
providing an on/off switch secured to the case adjacent the catch;
pressing the on/off switch with a finger;
raising the finger from the on/off switch and lifting the tab upwardly substantially simultaneously.
